(19) United States
(12) Patent Application Publication
(10) Pub. No.: US 2026/0299609 A1
(43) Pub. Date: Oct. 1, 2026

(54) Multi-Modal Target Object Location for Mobile Robots

(71) Applicant: Skild-Fetch LLC, Pittsburgh, PA (US)

(72) Inventors: Gireesh S. Dharwarkar, 49 Kentwood Crescent (CA); Timothy B. Austin, Stony Brook, NY (US); Steffen Fuchs, San Jose, CA (US); Benjamin Narin, San Jose, CA (US); tori Fujinami, Bozeman, MT (US)

(73) Assignee: Skild-Fetch LLC, Pittsburgh, PA (US)

(21) Appl. No.: 19/097,740

(22) Filed: Apr. 1, 2025

(51) Int. Cl. G05D 1/667; G05D 1/247; G05D 105/28

(52) U.S. Cl. CPC G05D 1/667; G05D 1/247; G05D 2105/28

(57) ABSTRACT

A method includes at a processor of a mobile robot, obtaining an identifier of a target object; at the processor, controlling a wireless transceiver of the mobile robot to receive the identifier from a tag associated with the target object; selecting, at the processor, a direction of travel based on a read zone orientation of the wireless transceiver corresponding to receipt of the identifier; controlling, at the processor, a locomotive assembly of the mobile robot to travel in the selected direction; capturing an image with a camera secured to the mobile robot; and detecting the target object in the image.

### BACKGROUND

Autonomous or semi-autonomous mobile robots can be deployed in facilities such as warehouses, manufacturing facilities, healthcare facilities, or the like, e.g., to move items within the relevant facility. The items may be supported on carts or the like, and the robots may be configured to engage with (or dock), and disengage from, the carts to move the carts about the facility. When the location of a given cart is unknown to a robot assigned to retrieve that cart, the robot may be unable to complete assigned tasks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of item-handing mobile robots deployed in a facility.

FIG. 2A is a diagram of a mobile robot of FIG. 1.

FIG. 2B is a diagram of certain internal components of the mobile robot of FIG. 2A.

FIG. 3 is a diagram of the mobile robot of FIG. 2A, illustrating sensor fields of view of the mobile robot.

FIG. 4 is a flowchart of a method of multi-modal target object location.

FIG. 5 is a flowchart of a targeting method corresponding to block 410 of the method of FIG. 4.

FIG. 6A is a diagram of a performance of block 505 of the method 500.

FIG. 6B is a diagram of another performance of block 505 of the method 500, following a performance of block 515.

FIG. 6C is a diagram of a further performance of block 505 of the method 500, following another performance of block 515.

FIG. 6D is a diagram of a still further performance of block 505 of the method 500, following a further performance of block 515.

FIG. 6E is a diagram illustrating a selected direction of travel at block 420 of the method of FIG. 4.

FIG. 7 is a diagram illustrating successive performances of blocks 425 and 435 of the method of FIG. 4.

FIG. 8 is a diagram illustrating selection of a direction of travel at block 420 of the method of FIG. 4, based on scan results from other mobile robots.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: at a processor of a mobile robot, obtaining an identifier of a target object; at the processor, controlling a wireless transceiver of the mobile robot to receive the identifier from a tag associated with the target object; selecting, at the processor, a direction of travel based on a read zone orientation of the wireless transceiver corresponding to receipt of the identifier; controlling, at the processor, a locomotive assembly of the mobile robot to travel in the selected direction; capturing an image with a camera secured to the mobile robot; and detecting the target object in the image.

Additional examples disclosed herein are directed to a mobile robot, comprising: a locomotive assembly; a wireless transceiver; a camera; and a processor configured to: obtain a identifier of a target object; control the wireless transceiver to receive the identifier from a tag associated with the target object; select a direction of travel based on a read zone orientation of the wireless transceiver corresponding to receipt of the identifier; control the locomotive assembly of the mobile robot to travel in the selected direction; capture an image with the camera; and detect the target object in the image.

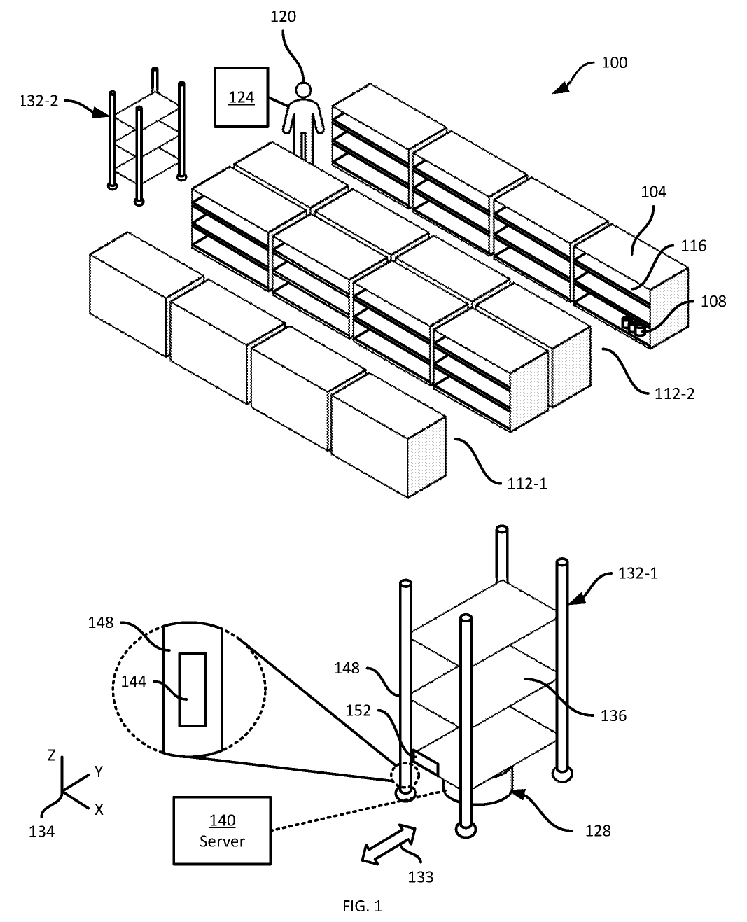

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as the aisles 112, and generically referred to as an aisle 112; similar nomenclature may be used herein for other components with hyphenated reference numbers). In the examples shown in FIG. 1, the support structures 104 include support surfaces 116 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1.

In other examples, the facility 100 can include fewer aisles 112 than shown, or more aisles 112 than shown in FIG. 1. The aisles 112, in the illustrated example, are formed by sets of support structures 104 (four on each side, although it will be understood that the aisles 112 may have a variety of lengths defined by varying numbers of support structures 104). The facility 100 can also have a wide variety of other aisle layouts, however. As will be apparent, each aisle 112 is a space open at opposing ends, and bounded on either side by one or more support structures 104. The aisles 112 can be travelled by humans, certain vehicles, and the like. In still further examples, the facility 100 need not include aisles 112, and can instead include assembly lines, storage areas on a floor of the facility, or the like.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders each indicating identifiers of certain items. The retrieval of an item 108 from a support structure 104 is also referred to as a pick operation. Picks can be performed in the facility 100 by a picker 120, such as a human worker. Although one picker 120 is shown in FIG. 1, it will be understood that various numbers of pickers can be deployed in the facility 100, e.g., depending on the size of the facility 100, the rate at which orders are received for fulfillment, and the like. Each picker 120 can operate a client computing device 124, such as a tablet computer, a smartphone, a wearable computer, or the like. The client device 124 enables the presentation of information to the picker 120, the capture of information from the picker 120, e.g., indicating completion of a pick task, or the like.

Order fulfillment in the facility 100 can be assisted by mobile robots, of which an example robot 128 is shown in FIG. 1. Additional robots 128 can be deployed in the facility 100, for example based on the size and/or layout of the facility 100. As will be discussed below, the facility 100 may contain a greater number of robots 128 than pickers 120 in some embodiments. In other embodiments, a number of robots 128 deployed in the facility 100 may be smaller than a number of pickers 120 in the facility 100.

To perform an order fulfillment task, or a portion thereof, the picker 120 can retrieve one or more items 108 from a support structure 104, and place the items 108 on a movable support, such as a wheeled cart 132-1 having one or more shelves or other support surfaces 136. Two example carts 132-1 and 132-2 are shown in FIG. 1, but it will be understood that the number of carts 132 deployed in the facility 100 may vary according to the size of the facility and/or other operational considerations. Further, the number of carts 132 deployed in the facility 100 need not match either of the number of robots 128, or the number of pickers 120.

The items 108 involved in fulfilling an order may be on support structures 104 at various locations in the facility. A given cart 132 may be moved about the facility 100 to collect the relevant items 108 for the order, e.g., before being moved to a pack-out area or the like. Moving of that cart 132 to various locations in the facility 100 can be performed by the robot 128. The robot 128 can navigate through the facility 100 while tracking its pose (e.g., location and orientation) relative to a coordinate system 134 previously established in the facility 100. The robot 128 can dock with a cart 132 and therefore move the cart 132 about the facility during such navigation. The robot 128 can receive target locations to navigate to, e.g., to collect a cart 132, and to move that cart 132 to a sequence of pick locations to receive items 108 from the support structures 104 (e.g., placed on the cart 132 by the picker 120). The target locations, and/or other control data, can be received at the robot 128 from a server 140 or other suitable computing device via one or more communication networks deployed within the facility 100. In other examples, the robot 128 can also be configured to dock with a target object other than a cart 132. For example, the robot 128 can be configured to transport equipment between locations in the facility 100 by docking with the equipment and navigating to such locations towing the docked equipment.

When the robot 128 approaches a cart 132, the robot 128 can initiate a docking procedure that involves positioning the robot in a predetermined pose relative to the cart 132 (e.g., dependent on the direction in which the robot 128 is intended to move the cart 132), and activating a docking accessory connected to the robot 128, to mechanically couple the robot 128 to the cart 132.

In some cases, a sequence of tasks assigned to a robot 128 may include docking with and transporting a cart 132 to a given location, decoupling from that cart 132, e.g., to recharge a battery of the robot 128, transport another cart 132, or the like, and then returning to dock with the first cart. The robots 128 and/or the server 140 can be configured to maintain last-known locations for the carts 132. For example, when a robot 128 undocks from the cart 132-1 to perform another task before returning to the cart 132-1, the robot 128 can store a location of the cart 132-1, e.g., as the location of the robot 128 itself in the coordinate system 134 at the time of decoupling. The stored location permits the robot 128 to return to the cart 132-1. However, while the robot 128 is decoupled from the cart 132-1, the cart 132-1 may be moved, e.g., by the picker 120, such that the true location of the cart 132-1 no longer matches the location stored by the robot 128. When the robot 128 returns to the stored location, the cart 132-1 may therefore not be present. As a result, the robot 128 may fail to complete the assigned sequence of tasks.

While deploying a sensing network, e.g., including a plurality of radiofrequency identification (RFID) readers, in the facility to detect RFID tags affixed to the carts 132 and continuously triangulate the position of each cart 132 may facilitate the retrieval of carts 132 by robots 128, deploying such systems can be costly and complex.

As described below, the robot 128 is configured to implement functionality, e.g., independently and/or in conjunction with the server 140, to locate a target object such as a cart 132 when the target object is not found at an expected location (e.g., a previously stored location for the target object). The functionality implemented by the robot 128 uses multiple sensing modalities, e.g., image-based detection and short-range wireless communications, such as RFID, Bluetooth or the like, permitting the robot 128 to locate a cart 132 over various ranges, including those at which image-based identification may be impractical. The functionality implemented by the robot 128 also does not rely on a facility-wide system of RFID readers or the like to locate the carts 132.

The carts 132 (and/or any other suitable target objects to be located by the robots 128) can include one or more RF tags affixed thereto. For example, the cart 132-1 includes an RF tag 144, affixed to a leg 148 of the cart 132-1. The RF tag 144 stores an identifier of the cart 132-1, e.g., uniquely identifying the cart 132-1 at least from the other carts 132 in the facility 100. The cart 132-1 can include a plurality of RF tags 144, e.g., one on each leg 148. The tags 144 can each store the same identifier in such embodiments. The tag 144 can also be placed elsewhere on the cart 132-1, in any location that lies within the field of “view” of a wireless transceiver such as an RFID reader of the robot 128.

The cart 132-1 can also include a visual indicator 152 encoding the above-mentioned identifier, such as a barcode (e.g., using a one-dimensional symbology or a two-dimensional symbology), a text string, or the like. The cart 132-1 can include multiple indicators 152, e.g., at different locations on the cart 132-1, each encoding the above-mentioned identifier.

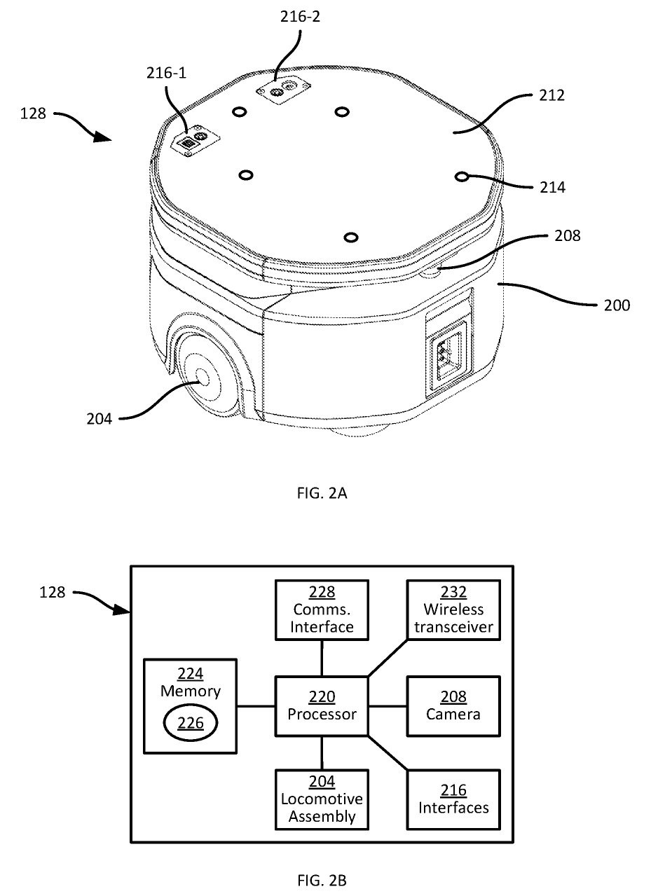

Before discussing the above-mentioned target locating functionality in greater detail, certain components of the robot 128 are discussed with reference to FIGS. 2A and 2B. As shown in FIG. 2A, the robot 128 includes a chassis 200 supporting various other components of the robot 128. In particular, the chassis 200 supports a locomotive assembly 204, such as one or more electric motors, e.g., powered by an onboard battery or other suitable power source, driving a set of wheels, tracks, or the like. The locomotive assembly 204 can include one or more sensors such as a wheel odometer, an inertial measurement unit (IMU), and the like. The chassis 200 also supports a camera 208. The chassis 200 can also support one or more additional navigational sensors, such as one or more cameras and/or depth sensors (e.g., lidars, depth cameras, time-of-flight cameras, or the like), e.g., substantially co-located with the camera 208 and/or distributed around a perimeter of the chassis 200. The camera 208 can be configured to capture image data depicting at least a portion of the physical environment of the robot 128. Data captured by the camera 208 and/or other navigational sensor(s) of the robot 128 can by used by processing hardware of the robot 128 for navigational purposes, e.g., path planning, obstacle avoidance, and the like. Data captured by the camera 208 can also be used to detect and identify target objects such as carts 132, e.g., by detecting and decoding the indicator 152.

The chassis 200 can also define a mounting surface 212, e.g., on an upper wall of the chassis 200, for removably receiving one or more accessories. The mounting surface 212 can removably receive a docking accessory, which can be affixed to the chassis 200 via fasteners such as bolts or the like, removably received in openings 214 on the mounting surface 212. In other examples the docking accessory can be permanently affixed to the chassis 200. The specific structure of the docking accessory can vary, e.g., including one or more extendable pins, clamps, or the like, to engage with a complementary structure on the cart 132.

The mounting surface 212 can also include one or more interface assemblies 216-1 and 216-2. The assembly 216-1 includes, in this example, a communications interface such as a Universal Serial Bus (USB) port, and a power delivery port. The assembly 216-2 includes, in this example, a communications interface such as an Ethernet port (e.g., an RJ-45 port), and a further power delivery port. A variety of other interface assembly configurations can also be implemented, e.g., incorporating two or more communications interfaces in one assembly 216 rather than divided between the assemblies 216-1, 216-2 as shown in FIG. 2. The interface assemblies 216 can connect with the docking accessory, e.g., to provide power and/or communications functionality to the docking accessory.

FIG. 2B is a block diagram of certain components of the robot 128, including certain internal components not shown in FIG. 2A. In particular, the robot 128 includes a processor 220, e.g., one or more central processing units (CPUs), graphics processing units (GPUs), or dedicated hardware controllers such as application-specific integrated circuits (ASICs). The processor 220 is communicatively coupled with a non-transitory computer readable medium such as a memory 224, e.g., a suitable combination of volatile and non-volatile memory elements. The memory 224 stores various data used for autonomous or semi-autonomous navigation, including computer-readable instructions executable by the processor 220 to implement navigational and other task execution functions. The memory 224 can store, for example, computer-readable instructions defining a navigational application 226 whose execution by the processor 220 configures the robot 128 to implement cart-locating functionality as described herein.

The processor 220 is also coupled with a communications interface 228, such as a wireless interface enabling the robot 128 to communicate with other computing devices, such as the server 140, client device 124, and other robots 128. The processor 220 can also be communicatively connected with the interface assemblies 216 mentioned above, e.g., to control accessories such as a docking accessory affixed to the chassis 200, and in some implementations, to receive sensor data from such accessories.

The robot 128 further includes a wireless transceiver 232 communicatively coupled with the processor 220. The wireless transceiver 232 can include an RF reader having one or more antennas configured to emit interrogation signals and capture backscatter from passive RF tags and/or signals from active RF tags in the vicinity of the robot 128 (e.g., tags 144). In some examples, the transceiver 232 can be a component of a docking accessory mentioned above, rather than supported within the chassis 200. In such examples, the transceiver 232 can receive power, and can communicate with the processor 220, via either or both of the interface assemblies 216.

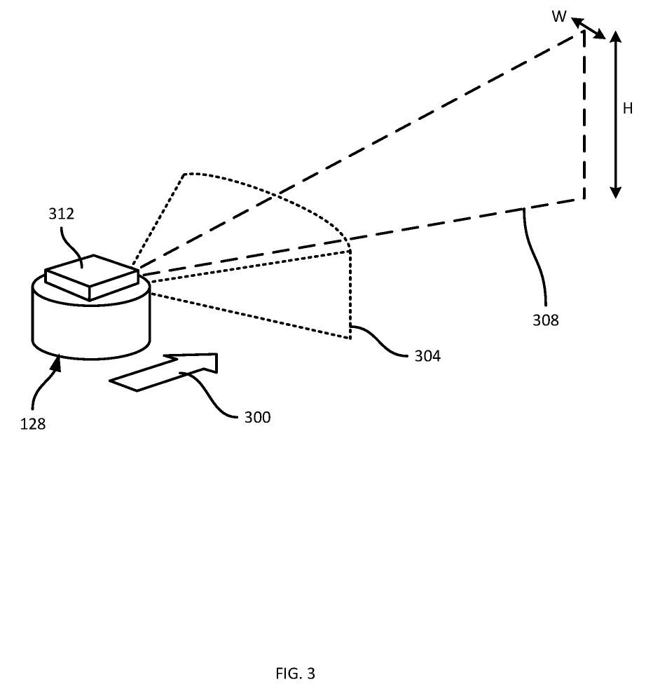

FIG. 3 is a diagram of the robot 128 facing a direction of travel 300, illustrating a field of view (FOV) 304 of the camera 208, and a field of view 308 of the transceiver 232. While the FOVs 304 and 308 are not necessarily shown to scale relative to one another or to the robot 128, and may have different shapes than illustrated, FIG. 3 indicates that the camera 208 is likely to have a shorter effective range than the transceiver 232. For example, the camera 208 may be suitable for detecting the indicator 152 at a distance of less than five meters, the transceiver 232 may be suitable for detecting the tags 144 at a distance of more than ten meters (e.g., up to twenty meters in some examples, dependent on the transmit power of the transceiver 232 and on the other objects in the vicinity of the robot 128). The transceiver 232, when implemented as an RFID reader, for example, can include one or more vertically polarized antennas such that the FOV 308 has a small width W relative to its height H. As will be apparent to those skilled in the art, the narrowness of the FOV 308 (e.g., defined by the beam width generated by the transceiver 232) is exaggerated in FIG. 3. The FOV 308 may have a greater width than illustrated in practice, e.g., up to about 60 degrees.

The restricted width of the FOV 308 may facilitate the determination of a heading from the robot 128 towards a tag 144. Also shown in FIG. 3 is a docking accessory 312, e.g., mounted on the chassis 200. The docking accessory 312 can include the transceiver 232, in some examples.

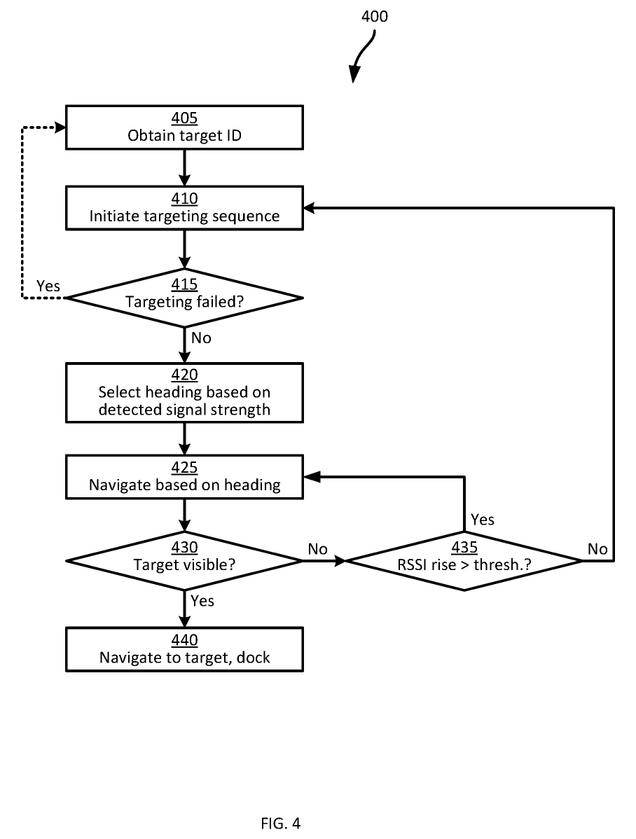

Turning to FIG. 4, a method 400 of multi-modal target object location is illustrated. The method 400 is described below in conjunction with its performance by the robot 128, e.g., via execution of the application 226 by the processor 220, and/or by equivalent dedicated hardware elements as noted earlier.

At block 405, the robot 128 is configured to obtain a target identifier, e.g., an identifier of a cart 132 or other target object to which the robot 128 is expected to navigate. Obtaining the target identifier can include receiving an instruction from the server 140, e.g., including the identifier and, in some examples, a last-known location of the relevant cart 132 in the coordinate system 134. In some examples, obtaining the target identifier can include retrieving the target identifier from the memory 224, e.g., when the target identifier was previously stored upon receipt of an instruction from the server 140.

The robot 128 can also be configured, at block 405, to navigate to a last known location corresponding to the target identifier, when such a location is available. For example, if the robot 128 previously stored a location in the memory 224 (e.g., in the coordinate system 134), the robot 128 can retrieve that location and travel to the retrieved location, e.g., using a map of the facility 100 which may be stored locally at the robot 128 or retrievable from the server 140. The robot 128 may, for example, have previously interacted with the cart 132 and deposited the cart at the stored location. In other examples, as noted above, the server 140 may provide a last known location of the cart 132 to the robot 128. When no last known location is available, the robot 128 can proceed directly to block 410.

At block 410, the robot 128 is configured to initiate a targeting sequence. The targeting sequence serves to visually locate the cart 132 corresponding to the identifier from block 405 (e.g., permitting initiation of a docking operation), or if the cart 132 cannot be visually located, to select a direction of travel towards the cart 132. As discussed below, the targeting sequence performed at block 410 can be used to select an initial direction of travel, as well as to refine or otherwise update a direction of travel later in the performance of the method 400.

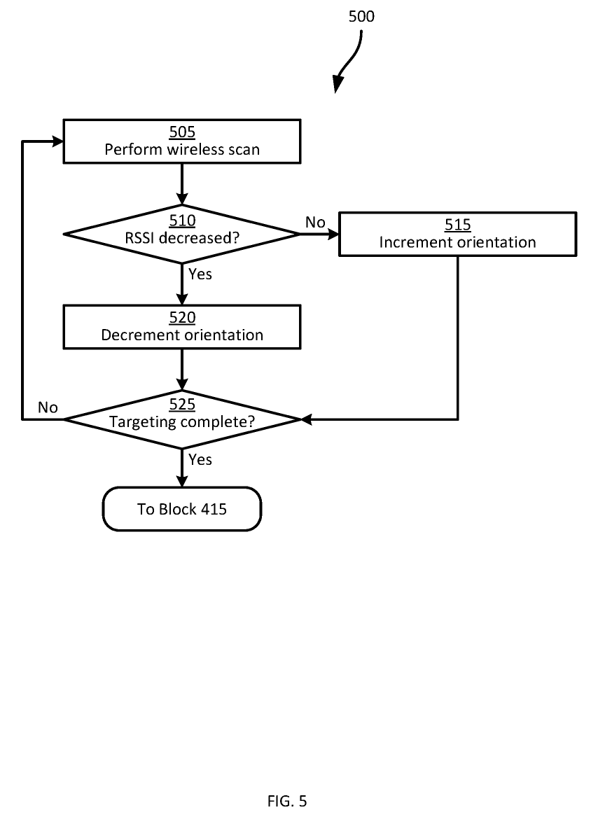

In general, the performance of block 410 includes performing a plurality of wireless scans with the transceiver 232, each at a different orientation. The robot 128 can also be configured to capture images with the camera 208 at each orientation. Turning to FIG. 5, a method 500 of performing block 410 is illustrated. At block 505, the robot 128 is configured to perform a wireless scan, e.g., by generating an RFID interrogation signal at a given orientation (that is, aimed in a given direction within the facility 100). The interrogation signal is configured to detect the tag 144, if the tag 144 is within the FOV 308 of the transceiver 232. The interrogation signal can include a mask configured to return only identifiers corresponding to carts 132, e.g., to filter out other items in the facility 100 with RFID tags (e.g., to filter out identifiers outside a predetermined range corresponding to the carts 132).

At block 510, the robot 128 is configured to determine whether a signal strength indicator (e.g., a Received Signal Strength Indicator, RSSI) associated with the identifier from block 405 has decreased since a previous performance of block 505. When the identifier is not detected at block 505 or is detected for the first time in this instance of the method 500, the determination at block 510 is negative. When the determination at block 510 is negative, the robot 128 is configured to increment a scan orientation at block 515. The scan orientation, e.g., corresponding to an angle of the FOV 308 in the XY plane of the coordinate system 134, can be incremented by a predetermine portion of the beam width of the transceiver 232. For example, if the beam width is about 60 degrees, the increment can be about 20 degrees, such that the next scan will overlap with the preceding scan. Various other increments can also be used. In some examples, the increment can be dynamically selected, e.g., using larger increments if the identifier was not detected. Incrementing the scan orientation can include physically changing the orientation of the chassis 200 via control of the locomotive assembly 204. In other examples, e.g., if the transceiver 232 includes a phased array antenna, incrementing the scan orientation can include updating antenna element control weights to steer the beam of the next scan instead of physically changing the orientation of the chassis 200.

When the determination at block 510 is affirmative, e.g., when at least two detections of the identifier from block 405 have occurred, and the most recent detection is associated with a lower signal strength than a preceding detection, the robot 128 is configured to proceed to block 520. At block 520, the robot 128 is configured to decrement the scan orientation. That is, the robot 128 is configured to re-orient the chassis 200 and/or antenna(s) of the transceiver 232 in an opposite direction from the direction of increment used at block 515. In general, if signal strength received from the tag 144 is decreasing, the direction of increment is likely to be orienting the robot 128 further away from the tag 144, and updating the scan orientation in the opposite direction is more likely to continue successfully detecting the tag 144.

Following incrementing of the scan orientation at block 515 or decrementing of the scan orientation at block 520, at block 525 the robot 128 is configured to determine whether targeting is complete. Completion of the targeting sequence can include, for example, a determination that the tag 144 has been detected a threshold number of times during the performance of the method 500. The threshold can be selected to permit the collection of a sufficient number of detections to select a travel direction, without requiring a complete revolution in the scan orientation. The criteria evaluated at block 525 can also include whether the scan orientation has completed a full revolution via blocks 515 or 520 (e.g., whether or not a threshold number of detections has occurred). Following an affirmative determination at block 525, the robot 128 proceeds to block 415 of the method 400. When the determination at block 525 is negative, the robot 128 returns to block 505 to perform another scan operation.

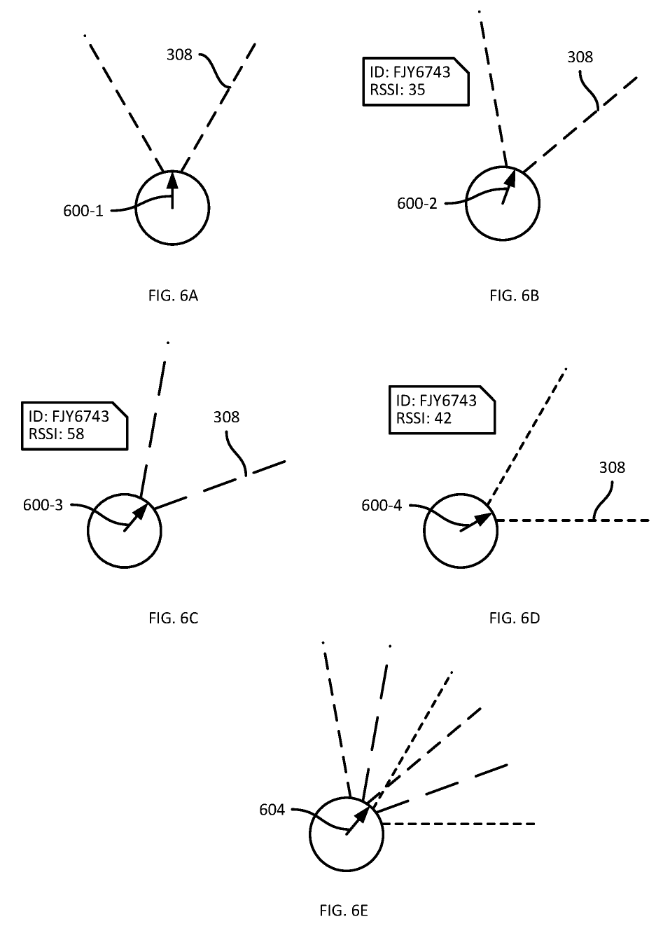

Turning to FIGS. 6A-6D, four successive performances of block 505 are shown, with respective scan orientations (corresponding to an angle towards which the FOV 308 is directed). In FIG. 6A, the robot 128 performs a scan that does not detect the tag 144 at a first orientation 600-1 (e.g., zero degrees). The determination at block 510 is therefore negative, and the orientation 600-1 is incremented to an orientation 600-2 shown in FIG. 6B (e.g., 20 degrees). The direction of increment can be reversed in other examples. The detection threshold applied at block 525 is three in this example (a wide variety of other thresholds can also be used), and the determination at block 525 is therefore negative.

At the second scan operation in FIG. 6B, the robot 128 detects the identifier of the cart 132-1 (e.g., “FJY6743”). A signal strength indicator in the form of an RSSI value is also generated in connection with the detection. The determination at block 510 is again negative, and the robot 128 increments the scan orientation to a third orientation 600-3 shown in FIG. 6C (e.g., 40 degrees). Following a third scan, the robot 128 detects the identifier with a greater RSSI than in FIG. 6B. The determination at block 510 is therefore once again negative, and the scan orientation is incremented to a fourth orientation 600-4 (e.g., 60 degrees) as shown in FIG. 6D.

At the fourth scan, the robot 128 detects the identifier, but the signal strength has decreased relative to the third scan shown in FIG. 6C. The determination at block 510 is therefore affirmative, and the scan orientation is decremented for the next scan at block 520. However, the determination at block 525 is affirmative because the identifier of the cart 132-1 has been detected three times. The robot 128 therefore proceeds to block 415 instead of performing a further scan.

Returning to FIG. 4, at block 415 the robot 128 is configured to determine whether the targeting sequence failed to detect the identifier from block 405. When the determination at block 525 was affirmative because a complete revolution in scan orientation was completed without any detections of the identifier, for example, the determination at block 415 is affirmative. The robot 128 may then terminate performance of the method 400, or return to block 405 to await receipt of a different identifier or an updated last-known location for the previous identifier.

When the determination at block 415 is negative, the robot 128 proceeds to block 420. At block 420, the robot 128 is configured to select a heading (that is, a direction of travel relative to the coordinate system 134) based on scan results from the method 500. For example, the robot 128 can average the scan orientations at which the relevant cart identifier was detected in the targeting sequence. As shown in FIG. 6E, a travel direction 604 of 40 degrees (from vertical) may therefore be selected. In other examples, the scan orientations can be weighted according to signals strength indicators, such that the orientation 600-3 is weighted more heavily in the above-mentioned average than the orientation 600-3, which is in turn weighted more heavily than the orientation 600-2.

Referring again to FIG. 4, at block 425 the robot 128 is configured to navigate according to the selected direction of travel from block 420. The robot 128 can be configured to monitor its vicinity visually, via the camera 208, and can determine periodically at block 430 whether the target is visible. For example, the robot 128 can capture a sequences of images via the camera 208, and determine whether the indicator 152 is present in any of those images. When the determination at block 430 is negative, the robot 128 proceeds to block 435. When the determination at block 430 is affirmative, the robot 128 can switch to visual navigation and proceed to navigate to the cart 132-1 and dock at block 440.

At block 435, the robot 128 is configured to determine whether to update the direction of travel. As will be apparent to those skilled in the art, wireless scanning, e.g., based on RFID protocols or the like, has limited directionality. That is, it may be difficult to determine an accurate direction from the robot 128 towards the cart 132-1 based on RFID scans, particularly in an environment prone to various forms of interference, e.g., multipath reflections and attenuation of RF signals due to physical obstacles. The direction of travel selected at block 420 may therefore have some degree of inaccuracy.

The robot 128 is configured to periodically scan for the tag 144 during travel at block 425. At block 435, the robot 128 is configured to determine whether a signal strength indicator associated with the most recent detection of the tag 144 is greater than a preceding scan (e.g., performed at least a threshold distance before the current scan) by at least a predetermined threshold. In other words, if the direction of travel selected at block 420 is accurate, the signal strength associated with successive detections of the tag 144 along that direction of travel are expected to increase. If the signal strength associated with such detections begins to decrease, or slows its increase, that may indicate that the direction of travel is inaccurate and the tag 144 is located further from the center of the FOV 308 (and may eventually fall outside the FOV 308).

When the determination at block 435 is affirmative, indicating that return signal strength for the tag 144 is increasing by at least a threshold rate during navigation along the current heading, the robot 128 can return to block 425 and continue along the same direction of travel, periodically scanning for the tag 144.

When the determination at block 435 is negative, the robot 128 returns to block 410 to perform another targeting sequence, e.g., beginning with the current direction of travel as the scan orientation at block 505. In some examples, the determination at block 435 can also include a determination of whether the robot 128 has travelled more than a threshold distance since beginning travel on the selected heading at block 425, e.g., corresponding to a maximum range of the transceiver 232 or the like.

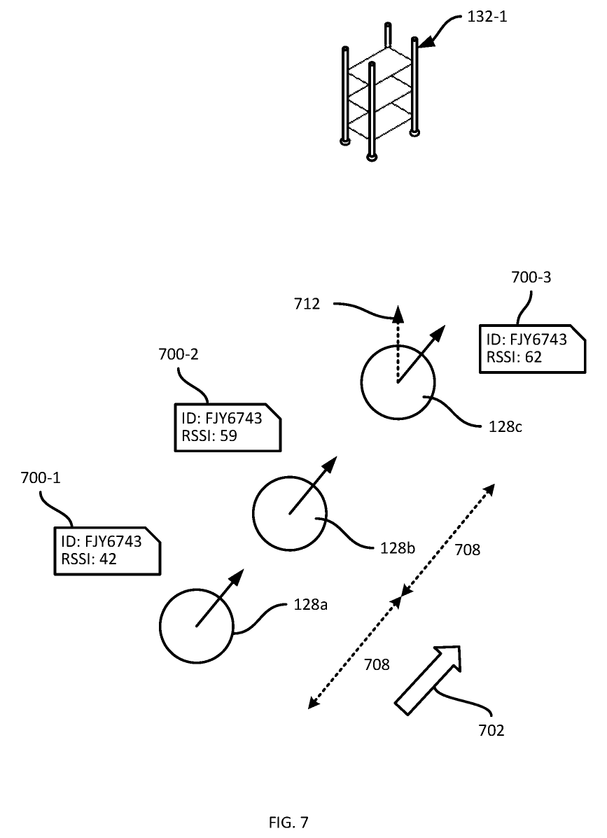

Turning to FIG. 7, the robot 128 is shown in three successive positions 128a, 128b, and 128c, while travelling along a direction 702 selected at block 420. At each position, the robot 128 has captured scan data 700-1, 700-2, 700-3 respectively, including the identifier of the cart 132-1, and a signal strength indicator. For illustrative purposes, the threshold signal strength increase evaluated at block 435 is ten, for a threshold travel distance 708. It will be appreciated that a wide variety of other thresholds can also be employed. As seen in FIG. 7, the scan data 700-2 indicates a rise in RSSI greater than ten between the positions 128a and 128b, and the determination at block 435, at the position 128b, is affirmative. At the position 128c, however, the rise in RSSI over the distance 708 is smaller than the above threshold, and the determination at block 435 is therefore negative. The robot 128 is thus configured to perform the method 500, to select a new direction of travel 712, before returning to block 425.

The robot 128, by performing the methods 400 and 500, can thus locate a cart 132 that is not at a last known location, or for which no last known location is available, at a greater distance than visual detection alone may permit.

The robot 128 can also implement various other functions. In some examples, the robot 128 can be configured to report identifiers of carts 132 or other target objects distinct from the identifier received at block 405 to the server 140. Reported identifiers can be provided to the server 140 by the robot 128 along with the pose (e.g., location and orientation) of the robot 128 at the time each reported identifier was captured. The server 140 may, in other words, receive cart identifiers from one or more robots 128. When the server 140 has received a sufficient number of reports for a given identifier, the server 140 may be able to triangulate the location of the corresponding cart 132, e.g., and provide that location to one or more robots 128.

The server 140 can also receive locations of carts 132 from the robots 128, e.g., in response to detection visual detection of a cart 132 by a robot 128. That is, instead of or in addition to capturing a tag identifier from a tag 144 affixed to a cart 132, any given robot 128 can process images captured via its camera 208 to detect any carts 132 therein, as well as extract the cart’s identifier from the corresponding visual indicator 152. Based on the pose of the robot 128, and the position of the cart 132 detected in the image, the robot 128 or the server 140 can determine coordinates in the system 134 defining a location of the cart 132. The server 140 can therefore maintain one or more prior observations of actual locations for a cart 132, received from any of a variety of robots 128. When the server 140 provides a last known location of a cart 132 to a robot 128, the server 140 may, for example, provide a ranked list of recent observations of that cart 132 by any robot 128. The list may be ranked by age of observation, such that more recently observed locations for the cart 132 are prioritized over less recent observations.

The robot 128 can, in some examples, disable the transceiver 232 in response to an affirmative determination at block 430, e.g., to limit power consumption by the transceiver 232 when visual navigation to the target object is possible. In some examples, disabling the transceiver 232 as set out above may be suppressed if a battery level of the robot 128 exceeds a threshold.

As noted above, a plurality of robots 128 in the facility 100 can be configured to periodically scan for cart-associated tags 144 and report the results of such scans to the server 140. In further examples, selection of a heading at block 420 by a given robot 128, based on the results of the targeting process by that robot 128 according to the method 500, can be supplemented by tag reads performed by other robots 128. For example, each robot 128 can be configured to report cart identifiers detected via its transceiver 232 along with the pose of the robot 128 at the time of detection. The server 140 can be configured, instead of or in addition to triangulating a location of the corresponding cart 132 in the coordinate system 134, to provide such tag read data to another robot 128 currently searching for the corresponding cart 132.

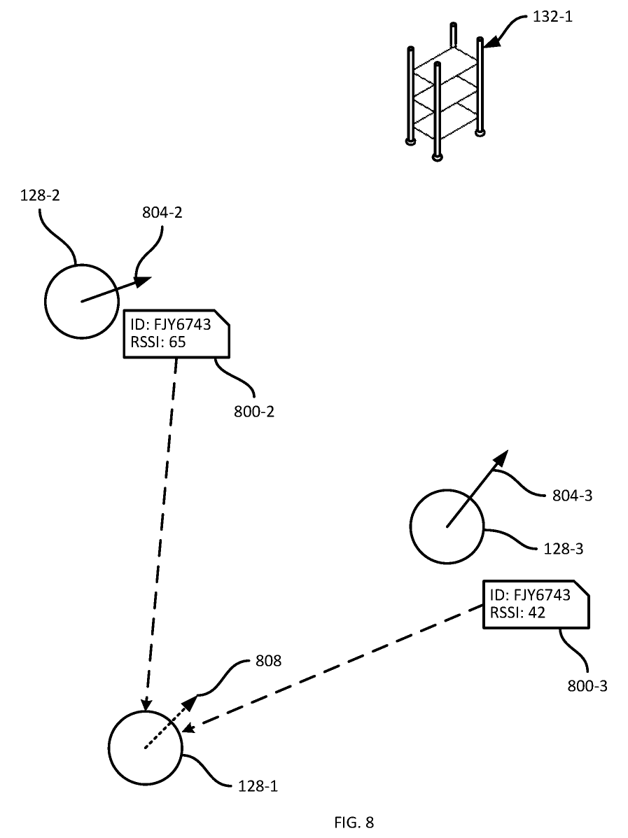

For example, referring to FIG. 8, a scenario is illustrated in which a robot 128-1 has been tasked with retrieving the cart 132-1. The robot 128-1 may receive few or no return signals from the tag 144 on the cart 132-1 at block 505. However, robots 128-2 and 128-3, which may be performing other tasks unrelated to the retrieval of the cart 132-1 (e.g., scanning for and/or retrieving other carts 132), periodically scan for tags and may therefore capture scan data 800-2 and 800-3, which can be transmitted to the robot 128-1 either directly or via the server 140. As shown, each of the scan data 800-2 and 800-3 includes the identifier of the cart 132-1, signal strength indicators, and pose information indicating the position and orientation of respective robots 128-2 and 128-3 at the time of capture.

The server 140, or the robot 128-1, can process the scan data 800 to determine a direction and/or distance from the locations of the robots 128-2 and 128-3 to the cart 132-1, e.g., based on the signal strength indicators and pose information mentioned above. For example, the server 140 and/or the robot 128-1 can generate vectors 804-2 and 804-3 corresponding to an estimated direction and distance (indicated by vector magnitude) from the locations of the robots 128-2 and 128-3 to the cart 132-1. Each vector 804 can be generated, for example, by selecting a direction for the vector 804 based on the pose of the corresponding robot 128 at the time that the tag 144 was scanned (or the pose of the transceiver 232 itself, if the transceiver 232 is movable relative to the chassis 200). For example, the direction can correspond to a midline that bisects the FOV 308 of the transceiver 232. If a plurality of scans of the same tag 144 were received from the same robot 128, e.g., captured by the robot via a targeting sequence as shown in FIG. 5, the direction can be determined as discussed above in connection with FIG. 5, e.g., averaging the scan orientations at which the relevant cart identifier was detected in the targeting sequence.

A distance (e.g., corresponding to a magnitude of a vector 804) can be determined based on one or more signal strength indicators. For example, the server 140 or the robot 128 can determine a distance estimate that is proportional to a signal strength indicator, e.g., according to a look-up table of empirical measurements previously generated and stored, and/or based on a predetermined maximum read distance. In such instances, the estimated distance can be determined as a fraction of the predetermined maximum read distance, the fraction selected according to the ratio of actual signal strength indicator to maximum signal strength indicator. In further examples, a distance estimate can be generated by estimating the round trip time (RTT) of the interrogation signal from the wireless transceiver 232.

The robot 128-1 can select a heading 808 by, for example, determining an intersection of the vectors 804 (e.g., via a least squares computation or the like), and/or determining tag position estimates from the scan data 800 (e.g., based on the vectors 804 and signal strength indicators) and computing an average of the location estimates, or the like. In some cases, the scan data may be sufficient to determine a location of the cart 132 in the coordinate system 134 (e.g., based on an intersection of vectors 804). In those cases, and/or when a last known location is received from the server 140 or another robot 128, the robot 128-1 can employ a map of the facility to determine a path towards that location, traveling through the aisles 112 and navigating around mapped obstacles, for example. According to some aspects of the present disclosure, if the scan data 800 from the other robots 128 have been collected over an extended period of time, more recent scan data 800 can be given more weight than scan data 800 collected further in the past, when estimating the position of the cart 132-1.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
at a processor of a mobile robot, obtaining an identifier of a target object;
at the processor, controlling a wireless transceiver of the mobile robot to receive the identifier from a tag associated with the target object;
selecting, at the processor, a direction of travel based on a read zone orientation of the wireless transceiver corresponding to receipt of the identifier;
controlling, at the processor, a locomotive assembly of the mobile robot to travel in the selected direction;
capturing an image with a camera secured to the mobile robot; and
detecting the target object in the image.

2. The method of claim 1, further comprising:
in response to detecting the target object in the image, controlling the locomotive assembly to dock with the target object.

3. The method of claim 1, further comprising:
storing a first signal strength associated with receipt of the identifier;
prior to capturing the image:
controlling the wireless transceiver to receive a further instance of the identifier from the tag; and
determining whether a difference between the first signal strength and a further signal strength associated with receipt of the further instance of the identifier satisfies a criterion.

4. The method of claim 3, wherein the criterion comprises the further signal strength exceeding the first signal strength by a threshold.

5. The method of claim 3, further comprising:
when the difference satisfies the criterion, controlling the locomotive assembly to continue traveling in the selected direction.

6. The method of claim 3, further comprising:
when the difference does not satisfy the criterion, selecting an updated direction of travel, and controlling the locomotive assembly to travel in the updated direction.

7. The method of claim 6, wherein selecting the updated direction of travel comprises:
controlling the wireless transceiver to receive a plurality of additional instances of the identifier from the tag, each additional instance associated with a respective read zone orientation; and
selecting the updated direction of travel based on an overlapping portion of the respective read zone orientations.

8. The method of claim 7, wherein controlling the wireless transceiver to receive a plurality of additional instances of the identifier comprises:
for each of the additional instances, incrementing an orientation of the wireless transceiver based on a comparison of signal strengths associated with prior ones of the additional instances.

9. The method of claim 1, further comprising:
receiving, via the wireless transceiver, a second identifier corresponding to a second tag associated with a second target object; and
controlling a communications interface of the mobile robot to transmit scan data to a server, the scan data including (i) the second identifier, (ii) a signal strength associated with receipt of the second identifier, and (iii) a pose of the mobile robot corresponding to receipt of the second identifier.

10. The method of claim 9, further comprising:
receiving from the server, at the communications interface of a second mobile robot, a location of the second tag, the location determined at the server based on the scan data and further scan data from a further mobile robot;
wherein the server is configured to weight the scan data and the further scan data in determining the location of the second tag, according to respective ages of the scan data and the further scan data.

11. The method of claim 1, further comprising:
in response to detecting the target object in the image, disabling a tag-scanning function of the wireless transceiver.

12. A mobile robot, comprising:
a locomotive assembly;
a wireless transceiver;
a camera; and
a processor configured to:
obtain an identifier of a target object;
control the wireless transceiver to receive the identifier from a tag associated with the target object;
select a direction of travel based on a read zone orientation of the wireless transceiver corresponding to receipt of the identifier;
control the locomotive assembly of the mobile robot to travel in the selected direction;
capture an image with the camera; and
detect the target object in the image.

13. The mobile robot of claim 12, wherein the processor is further configured to:
in response to detecting the target object in the image, control the locomotive assembly to dock with the target object.

14. The mobile robot of claim 12, wherein the processor is further configured to:
store a first signal strength associated with receipt of the identifier;
prior to capturing the image:
control the wireless transceiver to receive a further instance of the identifier from the tag; and
determine whether a difference between the first signal strength and a further signal strength associated with receipt of the further instance of the identifier satisfies a criterion.

15. The mobile robot of claim 14, wherein the criterion comprises the further signal strength exceeding the first signal strength by a threshold.

16. The mobile robot of claim 14, wherein the processor is further configured to:
when the difference satisfies the criterion, control the locomotive assembly to continue traveling in the selected direction.

17. The mobile robot of claim 14, wherein the processor is further configured to:
when the difference does not satisfy the criterion, select an updated direction of travel, and controlling the locomotive assembly to travel in the updated direction.

18. The mobile robot of claim 17, wherein the processor is configured to select the updated direction of travel by:
controlling the wireless transceiver to receive a plurality of additional instances of the identifier from the tag, each additional instance associated with a respective read zone orientation; and
selecting the updated direction of travel based on an overlapping portion of the respective read zone orientations.

19. The mobile robot of claim 18, wherein the processor is configured to control the wireless transceiver to receive a plurality of additional instances of the identifier by:
for each of the additional instances, incrementing an orientation of the wireless transceiver based on a comparison of signal strengths associated with prior ones of the additional instances.

20. The mobile robot of claim 12, wherein the processor is further configured to:
receive, via the wireless transceiver, a second identifier corresponding to a second tag associated with a second target object; and
control a communications interface of the mobile robot to transmit to a server (i) the second identifier, (ii) a signal strength associated with receipt of the second identifier, and (iii) a pose of the mobile robot corresponding to receipt of the second identifier.

21. The mobile robot of claim 12, wherein the processor is further configured to:
in response to detecting the target object in the image, disable a tag-scanning function of the wireless transceiver.
